(19) United States
(12) Patent Application Publication
(10) Pub. No.: US 2002/0104809 A1
(43) Pub. Date: Aug. 8, 2002

(54) Coolant recovery system

(76) Inventor: Gary D. Southerland, Lewisville, TX (US)

Correspondence Address: THE LAW OFFICES OF H. DENNIS KELLY, 2401 TURTLE CREEK, DALLAS, TX, 75219, US

(21) Appl. No.: 09/779,232

(22) Filed: Feb. 8, 2001

(51) Int. Cl. B01D 21/02

(52) U.S. Cl. 210/800; 210/167; 210/322

(57) ABSTRACT

A method and apparatus for coolant recovery system is shown. A holding tank is positioned above a cleaning tank. The holding tank receives contaminated coolant from a pre-existing machine coolant tank, and the cleaning tank holds a quantity of relatively clean coolant. Contaminated coolant is pumped into the holding tank and allowed to settle, creating a thin layer of contaminants on top of the coolant. Clean coolant is pumped from the cleaning tank into the holding tank, causing the thin layer of contaminants to drain out of the holding tank via a skim line into a processing zone in the cleaning tank. The processing zone is designed to allow only the coolant portion of the skimmed liquid to pass to the remainder of the cleaning tank. The processed coolant remaining in the holding tank is then pumped back to the machine coolant tank.

### TECHNICAL FIELD

The invention relates to coolant treating, and in particular to both a method and an apparatus for separating and removing lubricating oil and other contaminants from manufacturing machinery coolant.

### BACKGROUND ART

Manufacturing machines that cut, drill, turn, and otherwise fashion metal pieces use a mineral oil or similar aqueous-based coolant to prevent overheating of cutting edges and the workpiece. The coolant inevitably becomes contaminated with metal particles, lubricating oil and other contaminants. If they are not removed, these contaminants will clog the coolant delivery system and cause the coolant to decompose and lose effectiveness. The oil, known as tramp oil, and the coolant also tend to emulsify quite readily, so that simple settling methods fail to provide substantial separation of the oil/coolant mixture.

Several methods have been devised for cleaning oily liquids, but they fail to satisfy the concurrent needs for inexpensive, simple operation and low coolant loss. Filtering methods are not fully effective because the oil and coolant are mechanically emulsified. Centrifugal methods can overcome the emulsification problem, but are relatively expensive to purchase and maintain.

U.S. Pat. No. 5,795,478 issued to Hirs, discloses an oil extraction system for industrial machining fluid that makes use of an assembly of nested horizontal polymer tubes, through which the machining fluid passes. The tubes are oleophilic, so that tramp oil in the fluid is attracted to the polymer and coalesces into droplets which are then separated from the coolant in a settling tank.

A commercially available apparatus, using a method similar to the Hirs patent, has multiple separation chambers packed with oleophilic spherical media. The emulsified oil is intended to adhere to the spherical media and coalesce into droplets that rise to the surface to form an oil layer. The unit is intended to run with a continuous, steady input of oily water, and required compressed air to operate, which is not present in every location. Also, the oily water fed to the unit must be pre-filtered before being sent to the separation chambers, to prevent harming the spherical media.

U.S. Pat. No. 4,422,931 issued to Wolde-Michael, discloses a device for cleaning tramp oil and contaminants from machine coolant. The oily coolant is fed to a first compartment and aerated to cause foaming of the oil, which is well known to hasten separation. The coolant and foamy oil are then fed into a larger main compartment via an inclined quietener baffle that is intended to minimize disturbance of the fluid. Oil is extracted through an outlet placed roughly at the level of the inclined baffle. Coolant exits through a vertical hairpin path having an agglomeration baffle that is intended to remove remaining tramp oil. If flow to the first compartment is interrupted, or when draining the main compartment, the level in the main compartment falls below the oil outlet, so that any remaining oil is sent out the coolant outlet. Rapid emulsification of the oil and coolant while passing through the hairpin path will likely make the agglomeration baffle largely ineffective.

U.S. Pat. No. 5,458,770 issued to Fentz, discloses another device for cleaning tramp oil and contaminants from machine coolant. This device uses several adjacent chambers separated by vertical rectangular baffles. Each baffle has a single aperture located at or near a corner, and diagonally opposite from the aperture-containing corner on the immediately adjacent baffles. The device is intended to trap the oil in the first chambers, while only coolant is intended to travel completely through the device. The device is continually full of coolant, whether filtering is being performed or not.

Some of the methods, such as the oleophilic coalescer devices described above, inadvertently promote the growth of anaerobic microbes that remain in the coolant, which can decompose the coolant and produce undesirable odors when the coolant is not used for long periods. Finally, most of the existing methods produce a disposal product that is predominantly made up of coolant, some as much as ninety percent coolant. This means that coolant must be replaced more frequently, raising operating costs. A waste product made up mostly of coolant also means that much more liquid must be disposed of, which creates environmental problems along with higher disposal costs.

A need exists for a method and apparatus that avoid or overcome the drawbacks of the existing methods and apparatus. A method and apparatus that are simple to understand, and relatively inexpensive both to purchase and to operate are also desirable.

### DISCLOSURE OF THE INVENTION

A structure having the desired features and advantages has an upper holding tank positioned above a lower, cleaning tank. Throughout the following discussion and in the claims, the term “line” includes any means used in the art for transporting fluid, which can be flexible where appropriate. Some non-limiting examples are pipes, tubing, and hoses.

A pump in a pre-existing machine coolant tank is connected to a fill line located in the holding tank, and provides the means for filling the holding tank from the machine coolant tank. A cleaning pump on the bottom of the cleaning tank connects to a clean coolant line that extends into the holding tank with the clean coolant line's outlet at a predetermined distance from the bottom of the holding tank. A skim line is also located in the holding tank, with its inlet located below both the fill line outlet and the clean coolant line outlet. The skim line empties into a processing zone within the cleaning tank, where solid contaminants are removed and emulsified oil is coalesced before the skimmed liquid enters the rest of the cleaning tank. The oil then settles out on top of the coolant. A return pump sends the processed coolant from the holding tank back to the pre-existing machinery coolant tank.

In a method for using the apparatus, contaminated coolant from the pre-existing machine coolant tank is pumped into the upper coolant tank. Preferably, air is allowed to mix with the oily coolant during pumping to promote the generation of an oil-based foam for more rapid oil/coolant separation. The contaminated coolant is allowed to settle, and contaminants that settle on top of the coolant are skimmed off into the processing zone. The remaining processed coolant in the holding tank is then pumped back to the pre-existing machine coolant tank for further use. Filtering can be optionally employed on the coolant returned to the machine coolant tank. Collected contaminants are periodically removed from the cleaning tank for disposal. When aeration is employed, an additional optional step can be performed, wherein clean coolant is pumped into the holding tank while the holding tank is being filled with the contaminated coolant so that liquid and foam are skimmed off to the processing zone.

Additional features and advantages of the invention will become apparent in the following detailed description and in the drawings.

### BRIEF DESCRIPTION OF THE DRAWINGS

FIG. 1 is a perspective view of a coolant recovery apparatus of the invention when in use, with pre-existing manufacturing machinery shown in dotted lining.

FIG. 2 is a cross-sectional front elevation thereof, taken along the sight lines indicated in FIG. 1, without liquid in the system, and with the front walls in the holding tank filtering zone and the cleaning tank processing zone removed to show additional internal elements.

FIG. 3 is a top plan view of the holding (upper) tank during use.

FIG. 4 is a top plan view of the cleaning (lower) tank during use.

### DETAILED DESCRIPTION OF THE PREFERRED EMBODIMENT

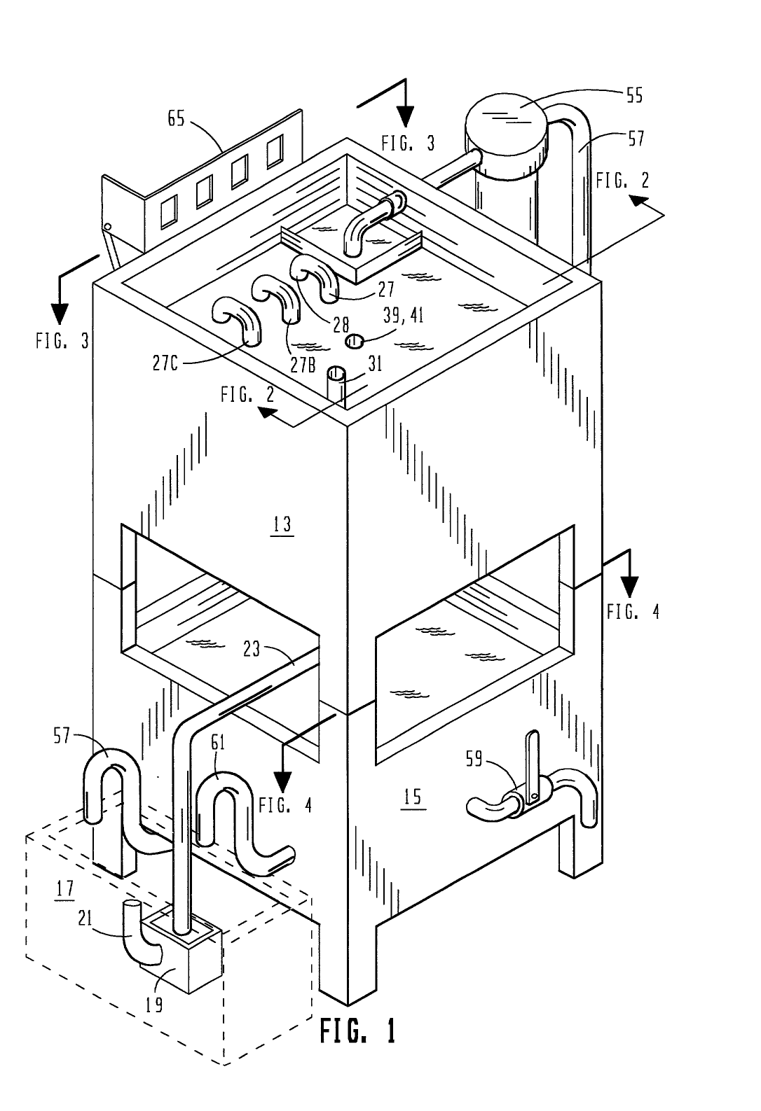

As shown in FIG. 1, the coolant recovery system 11 includes a holding tank 13 mounted above a cleaning tank 15. The holding tank 13 is designed to stack on top of the cleaning tank 15, and can be removed to allow cleaning and access to the inside of the cleaning tank 15. The cleaning tank 15 is filled with clean coolant prior to the first use of the system 11.

A low pressure pickup pump 19 is located within the pre-existing machine coolant tank 17. The pickup pump 19 has an inlet tube 21 that can be rotatably adjusted to allow the tube's inlet to be set over a range of heights. This rotatable feature serves two purposes: it prevents sending more liquid to the holding tank 13 than the tank can hold, and by proper adjustment of the inlet 21 air can be drawn into the pump 19 along with the liquid to aerate the oily contaminant, causing it to foam. Some machines will have more than one machine coolant tank. In this case, each tank would preferably have its own

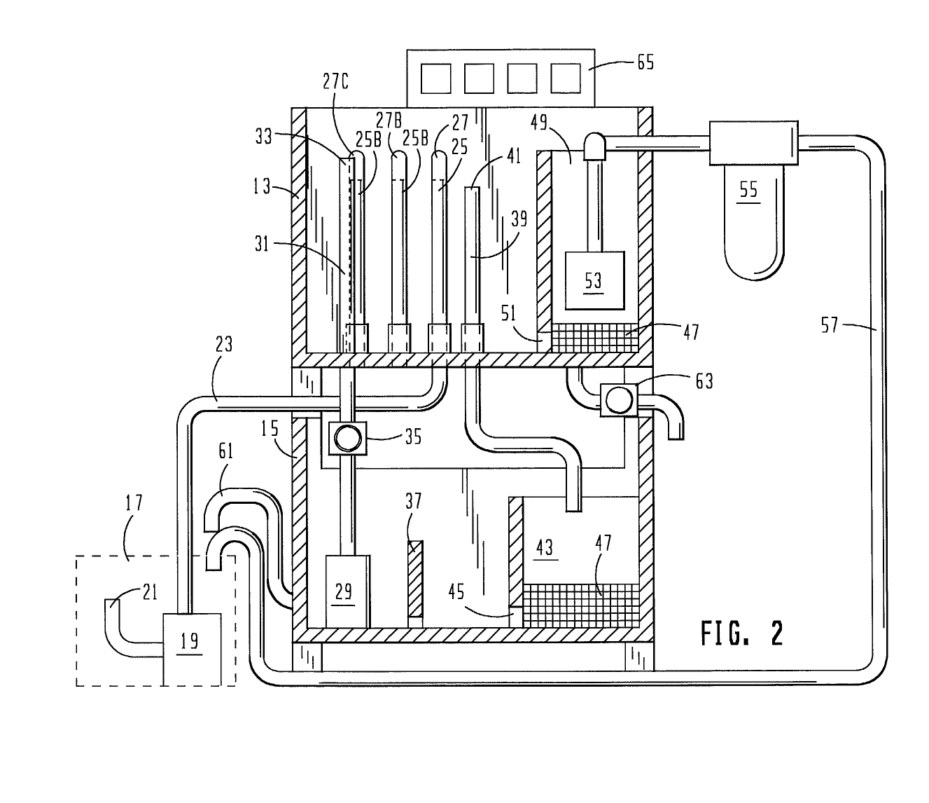

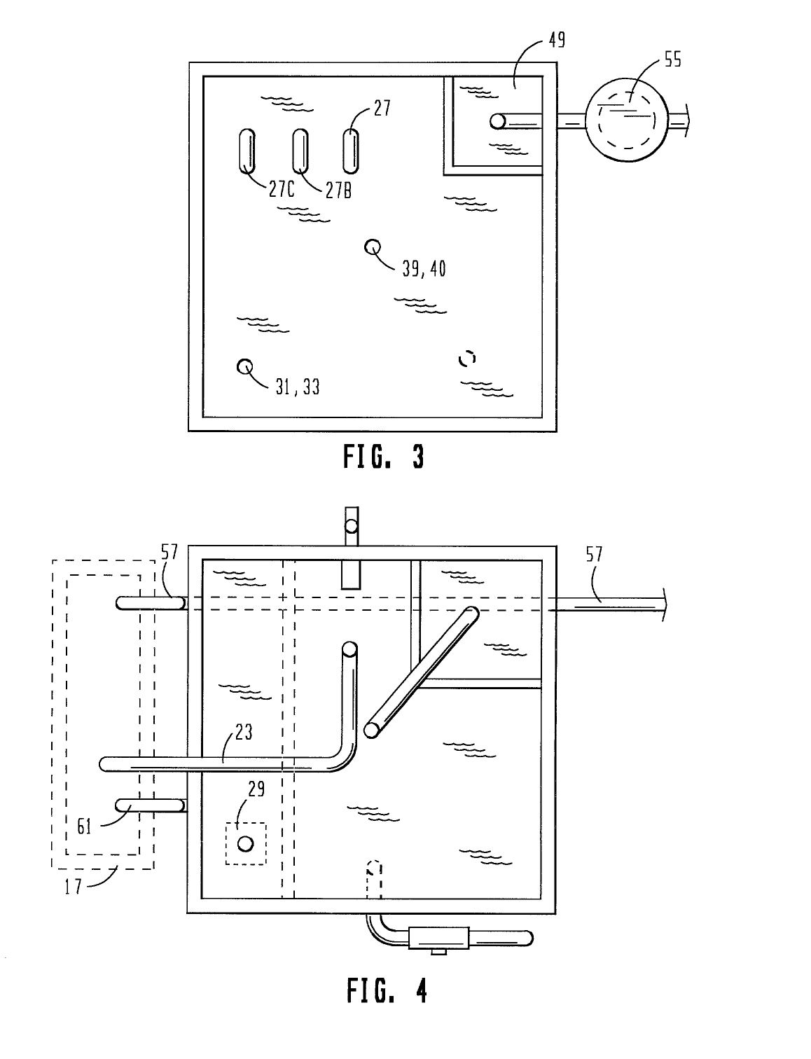

As shown in FIGS. 1 and 2, a line 23 connects the pickup pump 19 to a fill line 25 located in the holding tank. The fill line 25 terminates in a U-bend 27 with the outlet 28 at a predetermined height. In the case of multiple machine coolant tanks, each pump would connect to a separate fill line. Identical fill lines 25B and 25C with identical U-bends 27B and 27C can be provided for connection to additional machine coolant tanks. Any further description will reference only the first fill line 25 and its associated elements, but the description applies to the duplicate lines as well.

A cleaning pump 29 is located in the cleaning tank 15, and provides means for transferring coolant to the holding tank 13 via a clean coolant line 31 having an outlet 33 at a predetermined height above the fill line outlet 28. The coolant flow rate is controlled by a valve 35 or other well-known flow control means, such as a restriction orifice. A baffle 37 spanning the width of the cleaning tank helps prevent contaminants floating on the coolant from entering the cleaning pump 29, while an aperture 38 allows coolant to enter the cleaning pump 29 from the cleaning tank 15.

A skim line 39 is also located within the holding tank 13, with its inlet 41 at a predetermined height below the height of the fill line outlet 28. The skim line empties into a processing zone 43 located in the cleaning tank 15. The processing zone 43 is physically separated from the remainder of the cleaning tank 15 except for an aperture 45 located at the bottom of the processing zone 43. A filter 47 fills the bottom of the processing zone 43 to a height above the top of the aperture 45. The filter 47 is made of a material such as steel wool suitable for catching particulates that collect in the processing zone. The filter 47 also reduces flow turbulence and attracts the re-emulsified oil and causes it to coalesce. Both of these affects promote more rapid separation of the oil and coolant in the cleaning tank 15.

A filtering zone 49 is located within the holding tank 13, but is physically separated from the rest of the tank 13 except for an aperture 51. A return pump 53 is located in the filtering zone 49, and pumps processed coolant through a filter 55 and a return line 57 back to the machine coolant tank 17. The return pump 53 can be omitted and the coolant returned to the machine coolant tank 17 by natural flow (i.e. occurring strictly by gravitational force), but the filter 55 would need to be omitted or designed for very low pressure drop.

Entrained oil and other lighter-than-coolant contaminants will form a separate layer floating on top of the coolant in the cleaning tank 15. A valve 59 is provided for disposal of the collected contaminants. The liquid removed from the cleaning tank 15 will be almost completely made up of lighter-than-coolant contaminants, with relatively little entrained coolant. A waste product containing only ten percent coolant is typical. This permits significantly less frequent disposal, thereby reducing disposal costs.

An overfill line 61 is installed on the cleaning tank 15 to drain off any excess coolant to the machine coolant tank 17. The overfill line 61 connects near the bottom of the cleaning tank 15 to prevent sending lighter-than-coolant contaminants present in the cleaning tank 15 to the machine coolant tank 17.

As previously discussed, the holding tank 13 can be removed from its location above the cleaning tank 15 to allow both tanks to be accessed and cleaned. A drain valve 63 is provided on the bottom of the holding tank 13 to allow the tank to be emptied for easier removal, and to allow a quick flush-out of the holding tank 13. The drain valve 63 can also be used to return coolant to the machine coolant tank 17 by gravity flow. Preferably, the drain valve 63 should connect to the interior of the holding tank 13 through a vertical line having an inverted inlet (not shown), to prevent both solid particulates at the bottom of the liquid and lighter-than-coolant contaminants at the top of the liquid from being drained off.

Operation of the coolant recovery system is simple and straightforward. The process begins with the holding tank 13 substantially empty and with the cleaning tank 15 filled with clean coolant. The pickup pump 19 is turned on and run for a predetermined time to fill the holding tank 13 with contaminated coolant to a level just below the skim line inlet 41. As previously discussed, the pump inlet 21 is preferably adjusted to allow air to be drawn in with the contaminated coolant, so that the oil will form a foam that will separate more quickly from the coolant. During this step, oil will settle out from the coolant and form a layer on top of the coolant. This is especially true when the oil is aerated into a foam.

The second step is optional, but it is preferred that this step be performed, especially when a shorter overall operation time is desired. The step begins when most of the holding tank 13 has been filled, for example when the tank is filled to roughly seven-eighths of the height of the skim line inlet 41, measured from the bottom of the holding tank 13. At this point, the cleaning pump 29 is turned on, and a clean coolant flow is added via the clean coolant line 31 to the contaminated coolant. The holding tank is filled to the height of the skim line 39, so that liquid flows into the skim line at the skim line inlet 41 and flows into the processing zone 43. The flow is continued until the separated oil has been drawn off by the skim line 39. Both the machine coolant pump 19 and the cleaning pump 29 are then shut off. The point at which the pumps are shut off can be determined manually, or automatically.

In the next step, the contaminated coolant is left standing in the holding tank 13 for a predetermined time, during which the coolant and the immiscible contaminants settle out into separate layers. Particulates and other heavier-than-coolant contaminants will settle at the bottom of the tank, while lighter-than-coolant contaminants such as entrained oil will collect on top of the coolant. When the predetermined time (typically about 30 minutes) has elapsed, the next step is performed.

In the fourth step, the cleaning pump 29 is turned on and run for a predetermined time. As the holding tank 13 fills with coolant from the cleaning tank 15, the level of the coolant in the holding tank 13 will rise above the skim line inlet 41, and liquid will flow down the skim line 39 into the processing zone 43 in the cleaning tank 15. At first, this liquid will consist mostly of the lighter-than-coolant contaminants, but preferably the cleaning pump 29 continues to run until only clean coolant flows into the processing zone. As in the second step, he point at which the pumps are shut off can be determined manually, or automatically.

An alternative arrangement is envisioned for the apparatus, wherein the clean coolant line 31 can be omitted, and the clean coolant pumped into an opening at the bottom of the holding tank 13. This has the advantage that disturbance of the top surface of the liquid in the holding tank 13 is kept to a minimum, while a certain amount of disturbance is unavoidable from pouring the coolant down into the holding tank 13 from the clean coolant line outlet 33. However, this arrangement would make additional equipment necessary, such as a check valve or filter downstream of the flow control valve 35, to prevent particulates from backflowing through the valve and into the pump. This arrangement would also result require more frequent cleaning of the equipment. Therefore, the simpler arrangement shown in the figures is preferred.

In the final step, the return pump 53 is turned on and pumps the cleaned coolant in the holding tank 13 back to the machine coolant tank 17 via the tubing 57. The individual steps can be performed manually, or can be automatically performed by any known control scheme. A bank of timers 65 is preferred for simplicity and low cost.

Both the apparatus and the method have several advantages over the existing art. First, the apparatus is simple to construct, inexpensive, and easy to understand and operate. The two tanks can be easily separated, and all filter elements easily accessed and removed, so that the apparatus can be cleaned. The combination of the skim line 39 and the overfill line 61 make the system automatically self-draining back to the machine coolant tank 17, preventing the system from being accidently overfilled and spilling coolant. Since the control functions can be performed by turning pumps on and off for predetermined times, automatic control equipment can be very simple and inexpensive. The coolant in the tanks is exposed to air, preventing the growth of anaerobic microbes. Finally, the method and apparatus produces a waste that contains significantly less entrained coolant than existing methods and apparatus, thereby reducing the cost of coolant replacement and waste disposal.

The invention has been shown in only one embodiment, although other embodiments are described. It should be apparent to those skilled in the art that the invention is not limited to these embodiments, but is capable of being varied and modified without departing from the scope of the invention as set out in the attached claims.

1. A method of cleaning contaminated coolant produced by manufacturing machinery having a machine coolant tank for holding the contaminated coolant, comprising the steps of:
a) transferring the contaminated coolant from the machine coolant tank to a first vessel;
b) allowing the contaminated coolant to stand in the first vessel for a predetermined time, during which undissolved contaminants separate from the coolant;
c) following the standing step (b), pumping clean coolant into the first vessel and skimming liquid from the first vessel into a processing zone that is connected with a second vessel; and
d) transferring the processed coolant in the first vessel back to the machine coolant tank.

2. The method of claim 1, further comprising the step of periodically removing separated lighter-than-coolant contaminant from the second vessel.

3. The method of claim 1, wherein the clean coolant pumped into the first vessel in step (c) is supplied by the second vessel.

4. The method of claim 1, wherein the transferring step (d) is achieved by pumping, and further comprising the step of filtering the coolant pumped from the first vessel prior to its return to the machine coolant tank.

5. The method of claim 1, wherein the contaminated coolant is aerated during the transferring step (a) to form a contaminant-based foam, further comprising the step, beginning during step (a) and occurring with step (a), of pumping clean coolant into the first vessel and skimming liquid and foam from the first vessel into the processing zone.

6. A coolant recovery system for cleaning contaminated coolant from manufacturing machinery having a machine coolant tank, comprising:
a cleaning tank having a processing zone partially separated from the rest of the cleaning tank;
a holding tank located above the cleaning tank;
means for transferring fluid from the machine coolant tank to the holding tank;
means for transferring coolant from the cleaning tank to the holding tank;
the processing zone connecting to the cleaning tank through an aperture such that liquid can flow from the processing zone to the cleaning tank; and
a skim line having an inlet located within the holding tank at a predetermined height, and having an outlet emptying into the processing zone.

7. A coolant recovery system as recited in claim 6, further comprising a valve connected to the processing zone for draining the liquid in the processing zone.

8. A coolant recovery system as recited in claim 6, further comprising a return pump for pumping processed coolant from the holding tank to the machine coolant tank.

9. A coolant recovery system as recited in claim 8, further comprising a filter for filtering the processed coolant.

10. A coolant recovery system as recited in claim 6, wherein the means for transferring fluid from the machine coolant tank to the holding tank comprises a pickup pump located in or near the machine coolant tank, and a fill line for transferring liquid from the pickup pump to the holding tank.

11. A coolant recovery system as recited in claim 6, wherein the means for transferring coolant from the cleaning tank to the holding tank comprises a cleaning pump located in or near the cleaning tank, and a stand line for carrying liquid from the cleaning pump to the holding tank.

12. A coolant recovery system for cleaning contaminated coolant from manufacturing machinery having a machine coolant tank, comprising:
a cleaning tank having a processing zone partially separated from the rest of the cleaning tank;
a holding tank located above the cleaning tank;
a pickup pump located in or near the machine coolant tank;
a fill line for transferring liquid from the pickup pump to the holding tank;
a cleaning pump located in or near the cleaning tank;
a stand line for carrying liquid from the cleaning pump to the holding tank;
a processing zone connected to the cleaning tank through an aperture for allowing the flow of liquid between the processing zone and the cleaning tank; and
a skim line having an inlet located within the holding tank at a predetermined height, and having an outlet emptying into the processing zone.
